(19) United States
(12) Patent Application Publication
(10) Pub. No.: US 2022/0242161 A1
(43) Pub. Date: Aug. 4, 2022

(54) Eboardable

(71) Applicant: Kariesha Drayton, Athens, GA (US)

(72) Inventor: Kariesha Drayton, Athens, GA (US)

(73) Assignee: Drayton Kariesha, Athens, GA (US)

(21) Appl. No.: 17/163,505

(22) Filed: Jan. 31, 2021

(51) Int. Cl. B43L 1/00; G06F 1/16

(52) U.S. Cl. CPC B43L 1/00; G09F 9/301; G06F 1/1652

(57) ABSTRACT

This invention provides an unproved and consolidated solution to the traditional portable whiteboard. The board itself consists of a material that will not stick to itself when folded but adhere to other surfaces when unfolded Technology is embedded into this foldable device to ensure ideal brainstorming. Writing on the whiteboard allows users to brainstorm real time, while also recalling historical brainstorm sessions or ideas that are congruent with the current idea. Images and ideas captured ‘on the go’ via the app can be recalled. Complete with conventional capabilities real time brainstorming can be conducted with peers through video sharing capability or designated access identified by the user. All brainstorm ideas and sessions are stored within cloud storage. The whiteboard requires minimal storage requirements, as it can be rolled like a yoga mat or folded together like a blanket. The whiteboard will leverage a plug or pad charging device that is agnostic and compatible with technologies like apple, google and those of the like. Designed for optimal use, the whiteboard is offered in multiple geographic styles and sizes

### PORTABLE WHITEBOARD, DISPLAY APPARATUS AND TECHNOLOGY

This invention provides an improved portable whiteboard, display apparatus and technology; more particularly whiteboards or whiteboard like substances (chalk board, etc.) that can be set up in various locations without a defined space and/or digital solutions that allow for brainstorming and idea capture.

### BACKGROUND OF THE INVENTION

Conventional “peel & stick” whiteboards will allow you to “stick” a whiteboard like material to various surfaces and capture ideas. These surfaces can be relocated as users search for the appropriate location or change spaces; as well as rolled up for storage. Unfortunately, when a user would like to store their whiteboard, they must erase all the ideas they developed and recapture in an alternate location for later duplication. Additionally, when rolling up the whiteboard, the user must find material to prevent the whiteboard from sticking to itself.

There are also stand-alone digital whiteboards that allow you to virtually share, video—conference, collaborate and save projects with colleagues. These stand-alone whiteboards/screens require users to have a defined space to keep the board (whether mounted on the wall or on a rollable stand) and and/or a defined space to store the board when not in use. Additionally, the conventional boards offer folder structures that allow users to save their brainstorm to the cloud or defined storage. However, the boards do not offer the ability to search and recall previous ideas that can be combined, expanded upon, or removed.

Reference to related patents within the area of focus are listed below:

| | | |
|---|---|---|
| 6,883,140 | April 2005 | Acker et al. |
| 7,142,350 | November 2006 | May et al. |
| 7,305,381 | December 2007 | Poppink |
| 7,966,370 | June 2011 | Pegg et al. |
| 10,887,384 | January 2021 | Osborne et al. |
| 10,891,441 | January 2021 | Shima |
| 10,891,485 | January 2021 | Anorega et al. |
| 2009/0309846 | December 2009 | Trachtenberg |
| 2011/0,319,173 | December 2011 | Backer, Jonathan; et al. |

### BRIEF SUMMARY OF THE INVENTION

This invention provides an improved and consolidated solution to the traditional portable whiteboard. The board itself consists of a material that will not stick to itself when folded but adhere to other surfaces when unfolded. Writing on the whiteboard allows users to brainstorm real time, while also recalling historical brainstorm sessions or ideas that are congruent with the current idea. Images and ideas captured ‘on the go’ via the app can be recalled. Real time brainstorming can be conducted with peers through video sharing capability or designated access identified by the user. All brainstorm ideas and sessions are stored within cloud storage. The whiteboard requires minimal storage requirements, as it can be rolled like a yoga mat or folded together like a blanket. Designed for optimal use, the whiteboard is offered in various shapes and sizes.

### DETAILED DESCRIPTION OF THE INVENTION

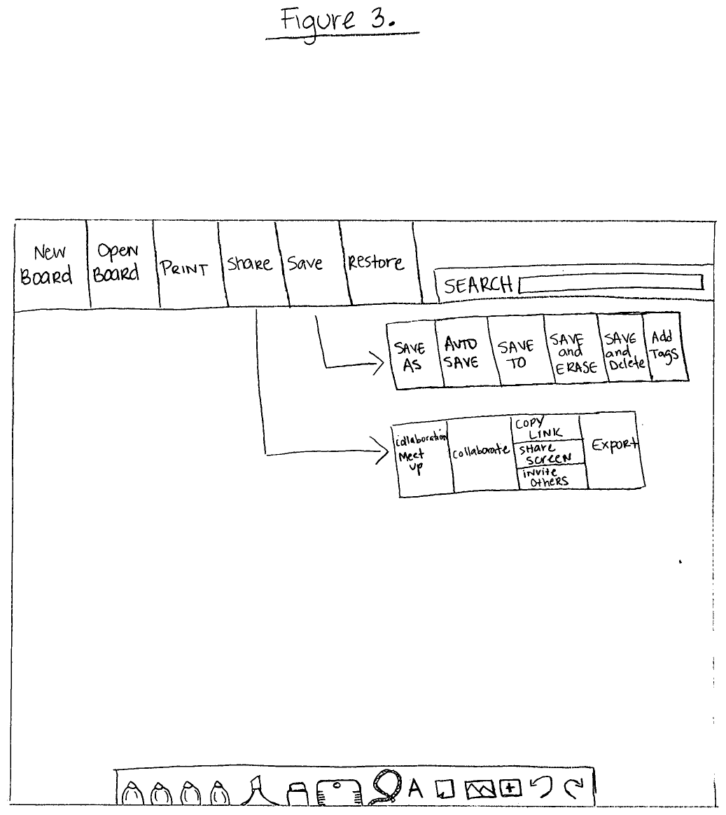

A detailed description of the invention is as follows:
1. The board will have the properties of a standard whiteboard.
2. The board will include a ribbon at the top of the board, like Microsoft products. The ribbon will be like PowerPoint, as shown in drawings in FIG. 3.
   New
   Open
   Search
   Tags/Labels
   Print
   Share
   Collaborate
   Collaboration Meet Up
   Export
   Save/Save As/Save To
   Restore
3. New: This will allow the owner to start a clean, new whiteboard
4. Open: This will allow the owner to open a previously saved whiteboard
5. Search: Like Word when you can search an article for a word or phrase. The owner will be able to search existing or previously saved whiteboards for words, phrases, or tags/labels. They then will be able to add it to the existing board or view previous thoughts to assist in new brainstorm.
6. Tags/Labels: Owners can assign tags to their whiteboards to make it easier to find.
7. Share: The board will be able to share content for immediate review through (a) inviting new collaborators to view the content (from existing contact list or via email), (b) sharing the content via a web meeting or (c) share a link for review later. The share buttons will be located on the top ribbon of the board.
8. Collaborate: The board will also allow collaborators to have varied levels of access. Access can be given at the idea level, the complete whiteboard level or at the category level. Additionally, collaborators can collaborate in real time or at various times; this functionality is like Microsoft Whiteboard. Rights include:
   Read Only
   Read/Write Access
   Admin Access
9. Collaboration Meet Up: Like Microsoft Teams, you can begin a meeting with a Whiteboard.
10. Export: The data can be exported into a Word document, PDF, or Excel file for additional editing.
   NOTE: The board will have Integration with common applications like Microsoft Suite, etc.
11. Save/Save as/Save to:
   The owner will save content to the cloud/app in three ways:
      Take a picture with cell phone device through app that will save to the cloud and to the app.
      Click save/save as in the ribbon of the board and it will automatically save to the cloud and to the app.
      The Autosave feature will capture work on the backend automatically.
   Additionally, you will have the ability to save and erase content or save and start new session.
   Version tracking is available on the board as changes to content are made by the original owner or during collaboration. The board will save variations to the cloud to ensure the original owner is able to see what changes are made. Like the Track Changes function within Microsoft Word the original owner can choose to accept the changes or delete them.
   The owner can create a folder structure to save ideas and make it easier to recall the information.
   The original owner will have access to suggested templates and designs, like PowerPoint, but also retain the original data collection style of the user.
   The data will be able to be saved as: an editable whiteboard frame, a word document, a PowerPoint, PDF, and an image.
   The save to functionality will allow the owner to append images, notes, etc. to previously saved whiteboards. For example, if you take a picture through the app of an item in a store and would like to log it with a previously saved board, the owner may do so.
12. Restore: This function will allow the board to restore recently deleted information or recently unsaved information to the whiteboard
13. Like Microsoft whiteboard, there will be a bottom ribbon that will allow for the user to elect what they would like to do with editing capabilities: Write, change pen strength, add text, add sticky notes, insert an image, lasso a group of items on board to move, undo, redo.
14. Like the Microsoft Surface, each board will be required to have specialized pens to write on the surface. The pen will be functioned with remote to erase items on the board.
15. Additional accessories will be offered: keyboard, mouse, and camera add-on (option to have it built in the device)
16. The data collected will be able to be recalled based on identified tags, key words, dates, categories, etc. through the search function. This feature, “remember” will ask the user to type in “remember: <insert phrase/tag/key word>
17. The technology that will allow the data to be collected on the cloud will be executed through a app.

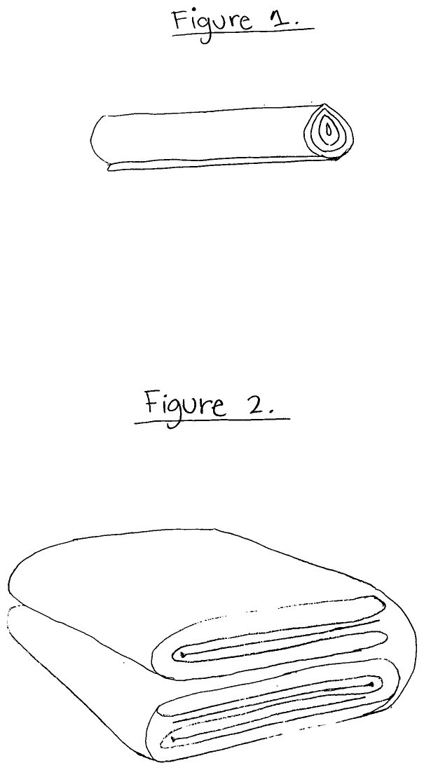

The app will act as a bridge for the data contained on the board and the cloud.
18. The app interface will allow the following:
   Take pictures of whiteboard to store to cloud.
   Take pictures from everyday life and store to cloud and/or save to a specific whiteboard.
   Access library of whiteboards saved to cloud.
   Collaboration within whiteboard
   Additional features provided on the whiteboard would also be available.
19. The board will offer suggestions leveraging machine learning for content that Is duplicated in ‘storage’ or that has like key words.
20. The board itself can be collapsed into a form that is easily stored and transported. The board will be collapsible, foldable, and rollable. As demonstrated in Drawings in FIG. 1-2.
21. The board material will not stick to itself when folded but adhere to other surfaces when unfolded.
22. The board can be applied to any wall space, windows, or open space with a hard backing.
23. The whiteboard will leverage a plug or pad charging device that is agnostic and compatible with technologies like apple, google and those of the like.
24. Through the app, the whiteboard will be accessible through a laptop, pad or any device that has access to internet without having the whiteboard setup.

### BRIEF DESCRIPTION OF DRAWINGS:

1. FIG. 1: The board itself can be collapsed into a form that is easily stored and transported. The board will be rollable, like a yoga mat.

2. FIG. 2: The board itself can be collapsed into a form that is easily stored and transported. The board will be collapsible and foldable, like a blanket.

3. FIG. 3: The board will have a screen that allows user to enact various commands. For example, open a New Board or Restore a previous board.

The Emdodiments of the invention which are exclusive property or privilege is claimed are defined as follows:

1. In a portable whiteboard, the combination of a device that can be rolled and folded, but not stick to itself; however, adhere to other surfaces when folded.

2. The combination defined in claim 1, is enhanced with the technological capabilities located there in the whiteboard.
